(19) United States
(12) Patent Application Publication
(10) Pub. No.: US 2026/0288585 A1
(43) Pub. Date: Sep. 24, 2026

(54) RECOVERING AND RESTORING DMA BUFFERS IN A GENAI MODEL BY AN ELECTRONIC DEVICE

(71) Applicant: SAMSUNG ELECTRONICS CO., LTD., Suwon-si (KR)

(72) Inventors: Irfan Abdul, Bengaluru (IN); Anuradha Kanukotla, Bengaluru (IN); Chulmin Kim, Suwon-si (KR); Kunal, Bengaluru (IN); Mohana Rao Vanimina, Bengaluru (IN); Davadas Puthusseril, Bengaluru (IN); Abhishek Singh, Bengaluru (IN); Syama Sudheesh, Bengaluru (IN); Sripurna Mutalik, Bengaluru (IN); Dwaraka Bhamidipati Sreevatsa, Bengaluru (IN)

(73) Assignee: SAMSUNG ELECTRONICS CO., LTD., Suwon-si (KR)

(21) Appl. No.: 19/555,374

(22) Filed: Mar. 3, 2026

Related U.S. Application Data
(63) Continuation of application No. PCT/KR2026/002773, filed on Feb. 13, 2026.

(30) Foreign Application Priority Data
Mar. 21, 2025 (IN) 202541026181
Sep. 8, 2025 (IN) 202541026181

(51) Int. Cl. G06F 11/14; G06F 13/30

(52) U.S. Cl. CPC G06F 11/1415; G06F 13/30; G06F 2201/805

(57) ABSTRACT

Embodiments herein provide a method and system for recovering and restoring DMA buffers in a GenAI model by an electronic device. The method includes obtaining, by the electronic device, a state of the GenAI model based on one or more parameters; determining, by the electronic device, a trigger for a GenAI model memory shrinker (GAMS) based on the state of the GenAI model; determining, by the electronic device, at least one buffer from a plurality of DMA buffers associated with the GenAI model that are safe for recovering based on triggering the GAMS; executing, by the electronic device, a GAMS memory recovery operation for the at least one DMA buffer from the plurality of DMA buffers; and executing, by the electronic device, a GAMS buffer restore operation for the at least one DMA buffer from the plurality of DMA buffers.

### CROSS-REFERENCES TO RELATED APPLICATIONS

This application is a bypass continuation application of International Application No. PCT/KR2026/002773, filed on Feb. 13, 2026, at the Ministry of Intellectual Property, of the Republic of Korea, as the Receiving Office, which is based on and claims benefit of Indian Provisional Application 20/254,1026181, filed on Mar. 21, 2025, and Indian Application (Complete Specification) 202541026181, filed on Sep. 8, 2025, at the Indian Intellectual Property Office, the contents of which are incorporated herein by reference in their entireties.

### FIELD

The present disclosure is related to the field of artificial intelligence. More particularly, the present disclosure is related to a method and system for recovering and restoring direct memory access (DMA) buffers in a generative artificial intelligence (GenAI) model by an electronic device.

### BACKGROUND

The advancements in GenAI models, including Large Language Models (LLM), Large Vision Models (LVM), and Large Multimodal Models (LMM), have significantly enhanced the capabilities of modern computing devices. These models, due to their extensive parameters, typically require substantial memory resources to function efficiently. For instance, a GenAI model with approximately three billion parameters may necessitate around 3 GB of memory. This substantial memory requirement is further exacerbated by the “always-on” nature of these models, which consistently occupy memory even when not actively in use.

One of the critical challenges in the deployment of GenAI models on devices, particularly those with limited hardware resources, is the management of memory. The GenAI models often utilize DMA buffers, which are shared across various subsystems within the device. These DMA buffers, once allocated, are locked and cannot be reclaimed by memory reclaimers. As a result, a significant portion of memory, ranging from 2 GB to 5 GB, remains occupied and unreclaimable, leading to low memory conditions.

This persistent occupation of memory by DMA buffers poses a significant problem when users attempt to launch memory-intensive applications, such as games. The lack of available memory can result in a sluggish user experience due to the inability to allocate sufficient memory for these applications. In such scenarios, the Low Memory Killer (LMK) mechanism is often triggered to free up memory by terminating background applications. However, since the memory occupied by DMA Buffers is not reclaimable, the effectiveness of the LMK mechanism is limited, leading to suboptimal memory management and degraded device performance.

The problem is further compounded by the growing complexity and size of GenAI models, which are expected to increase exponentially in the future. As GenAI model parameters expand, the memory requirements also rise, making it increasingly challenging to allocate and manage memory efficiently on mobile and end devices.

More efficient alternative techniques are needed to address the above mentioned problems and disadvantages.

### SUMMARY

According to an aspect of the disclosure, an embodiment provides a method a method for recovering and restoring DMA buffers in a GenAI model by an electronic device. The method includes obtaining, by the electronic device, a state of the GenAI model based on one or more parameters; determining, by the electronic device, a trigger for a GenAI model memory shrinker (GAMS) based on the state of the GenAI model; determining, by the electronic device, at least one buffer from a plurality of DMA buffers associated with the GenAI model that are safe for recovering based on triggering the GAMS; executing, by the electronic device, a GAMS memory recovery operation for the at least one DMA buffer from the plurality of DMA buffers; and executing, by the electronic device, a GAMS buffer restore operation for the at least one DMA buffer from the plurality of DMA buffers.

According to an aspect of the disclosure, an embodiment provides an electronic device for recovering and restoring DMA buffers in a GenAI model. The electronic device includes at least one processor; memory coupled to the at least one processor; and a DMA buffer controller communicatively coupled to the at least one processor and the memory, wherein the DMA buffer controller is configured to: obtain a state of the GenAI model based on one or more parameters; determine a trigger for a GenAI model memory shrinker (GAMS) based on the state of the GenAI model; determine at least one buffer from a plurality of DMA buffers associated with the GenAI model that are safe for recovering based on triggering the GAMS; execute a GAMS memory recovery operation for the at least one DMA buffer from the plurality of DMA buffers; and execute a GAMS buffer restore operation for the at least one DMA buffer from the plurality of DMA buffers, wherein the GAMS buffer restore operation comprises an explicit restore operation and an implicit restore operation.

According to an aspect of the disclosure, an embodiment provides a non-transitory computer readable medium storing instructions for recovering and restoring direct memory access (DMA) buffers associated with a generative artificial intelligence (GenAI) model. The instructions, when executed by at least one processor of an electronic device cause the electronic device to: obtain a state of the GenAI model based on one or more parameters; determine a trigger for a GenAI model memory shrinker (GAMS) based on the state of the GenAI model; determine at least one buffer from a plurality of DMA buffers associated with the GenAI model that are safe for recovering based on triggering the GAMS; execute a GAMS memory recovery operation for the at least one DMA buffer from the plurality of DMA buffers; and execute a GAMS buffer restore operation for the at least one DMA buffer from the plurality of DMA buffers, wherein the GAMS buffer restore operation comprises an explicit restore operation and an implicit restore operation.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### BRIEF DESCRIPTION OF THE DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 is a block diagram that illustrates a high-level architecture of GenAI applications.

FIG. 2 is a flow chart that illustrates a role of DMA buffers in GenAI applications.

FIG. 3 is a flow chart that illustrates a scenario where a GenAI model is loaded in a memory.

FIG. 4 is a schematic diagram of an electronic device configured to carry out the disclosed subject matter according to an embodiment as disclosed herein.

FIG. 5 is a block diagram that illustrates a high-level architecture of GenAI applications according to an embodiment as disclosed herein.

FIG. 6 is a flow diagram that illustrates a process of recovering and restoring DMA buffers in the GenAI model according to an embodiment as disclosed herein.

FIG. 7 is a flow diagram that illustrates a process of the GenAI state observer (GSO) according to an embodiment as disclosed herein.

FIG. 8 is a flow diagram that illustrates a process of identification of DMA buffers safe for recovery using the GAMS according to an embodiment as disclosed herein.

FIG. 9 is a flow diagram that illustrates a process of recovering a DMA buffer using the GAMS according to an embodiment as disclosed herein.

FIG. 10 is a block diagram that illustrates a DMA buffer recovery operation using the GAMS according to an embodiment as disclosed herein.

FIG. 11 is a block diagram that illustrates a DMA buffer recovery operation using the GAMS according to an embodiment as disclosed herein.

FIG. 12 is a flow diagram that illustrates a process for performing GAMS according to an embodiment as disclosed herein.

FIG. 13 is a flow diagram that illustrates a process for performing GAMS according to an embodiment as disclosed herein.

FIG. 14 is a block diagram that illustrates the GAMS according to an embodiment as disclosed herein.

FIG. 15 is a block diagram that illustrates the GAMS according to an embodiment as disclosed herein.

FIGS. 16A-B are flow diagrams that illustrates a process for recovering and restoring DMA buffers in the GenAI model according to embodiments as disclosed herein.

FIG. 17 is a sequence diagram that illustrates a process to use a backup trigger according to an embodiment as disclosed herein.

FIG. 18 is a sequence diagram that illustrates a process to use a restore trigger according to an embodiment as disclosed herein.

### DETAILED DESCRIPTION OF INVENTION

The embodiments provide a method and system for recovering and restoring DMA buffers in a GenAI model by an electronic device.

The embodiments monitor a state of a genAI model, including parameters such as active/inactive status, previous inference time, and usage patterns (e.g., user's usage patterns), to determine the appropriate timing for triggering a GenAI Model Memory Shrinker (GAMS).

The embodiments recover the memory of the GenAI model without unloading it, by preserving a context, pipeline, and graphs by accessing a DMA buffer via an identifier, signaling an NPU to detach from the DMA buffer, transferring the content of the DMA buffer to an external storage (such as NANDSWAP or ZRAM), modifying DMA buffer operations to GenAI DMA buffer operations, releasing physical memory, and updating MMU and IOMMU structures.

Yet another object of the embodiments herein is to automatically restore backed DMA buffers when consumers (CPU/NPU) access the DMA buffers, by accessing the DMA buffer via an identifier, allocating physical memory, copying content from NAND SWAP/ZRAM to the new allocated memory, updating MMU and IOMMU structures, and restoring modified GenAI DMA buffer operations to their original DMA buffer operations.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with a plurality of other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is existing in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits constituting a block be implemented by dedicated hardware, or by a processor (e.g., a plurality of programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

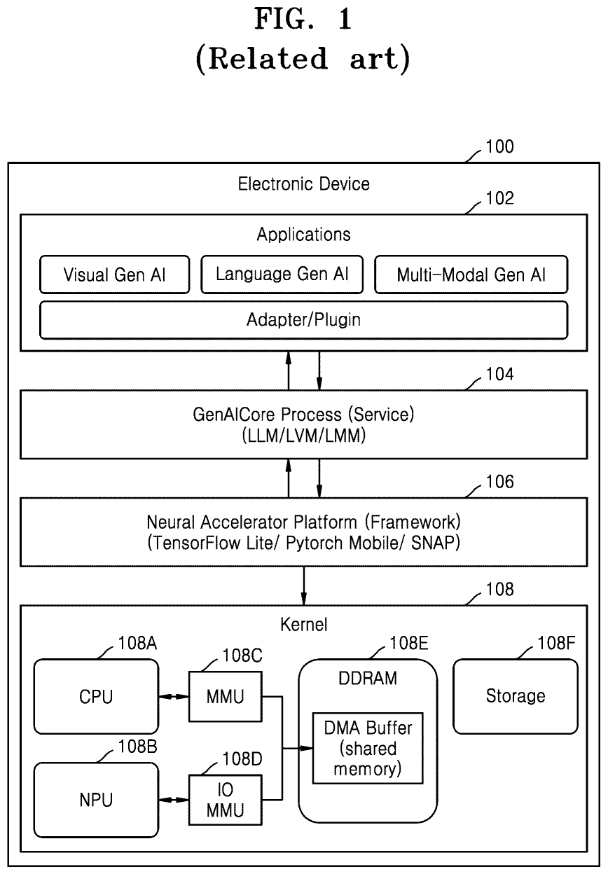

FIG. 1 is a block diagram that illustrates a high-level architecture of GenAI applications according to the related art. As shown, the block diagram includes an electronic device (100) that includes applications (102), services (104), a framework (106), and a kernel (108). The applications (102) include visual GenAI, language GenAI, multi-model GenAI, an adapter/plugin, and the like. The services (104) correspond to GenAI core processes. The framework (106) corresponds to a neural accelerator platform. Further, the kernel (108) includes a CPU (108A), a NPU (108B), a MMU (108C), an IO MMU (108D), a DDRAM (108E), and a storage (108F).

On device GenAI applications use a common foundation model to perform GenAI tasks. The applications don't embed the models, instead they communicate with GenAI Core. The GenAI Core will have all models. Based on the application request, an inference is executed from corresponding model. If model is not loaded, it will load the GenAI model. The GenAI Core Communicate with Neural Accelerator platform for example. The framework (106) creates shared buffers (DMA Buffers) and load the model weights in buffers and then share the buffers to the NPU (108B). During inference, the NPU (108B) access these buffers and perform computations on input tokens to generate output tokens. The output is shared back to GenAI Core and then passed to GenAI application to render the output.

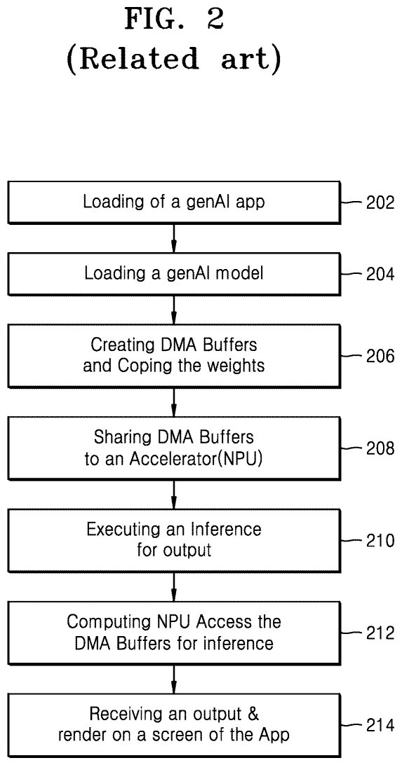

FIG. 2 is a flow diagram that illustrates a role of DMA buffers in GenAI applications according to the related art. The flow diagram includes steps (202-214). At step (202), the GenAI application is loaded on the electronic device (100). When a user clicks on a GenAI icon in the GenAI application, a request is sent to a GenAI Core to load the GenAI model. At step (204), the GenAI model is loaded upon loading of the GenAI application on the electronic device (100). The DMA buffers are created and model weights are copied to the DMA Buffers. Gen AI Models are usually very large occupying 3-5 GB of memory space.

At step (206), the DMA buffers are created and their weights are accordingly copied. At step (208), the DMA buffers are shared the NPU (108B). At step (210), when the user clicks a specific GenAI task (for example, writing style) an inference is executed on the user input text. At step (212), a NPU access for the DMA buffers is computed/determined. During the inference stage, the NPU (108D) accesses the model weight DMA Buffers and performs computations on input tokens to generate output tokens. At step (214), the GenAI application receives an output. This output is then rendered on a screen of the electronic device (100).

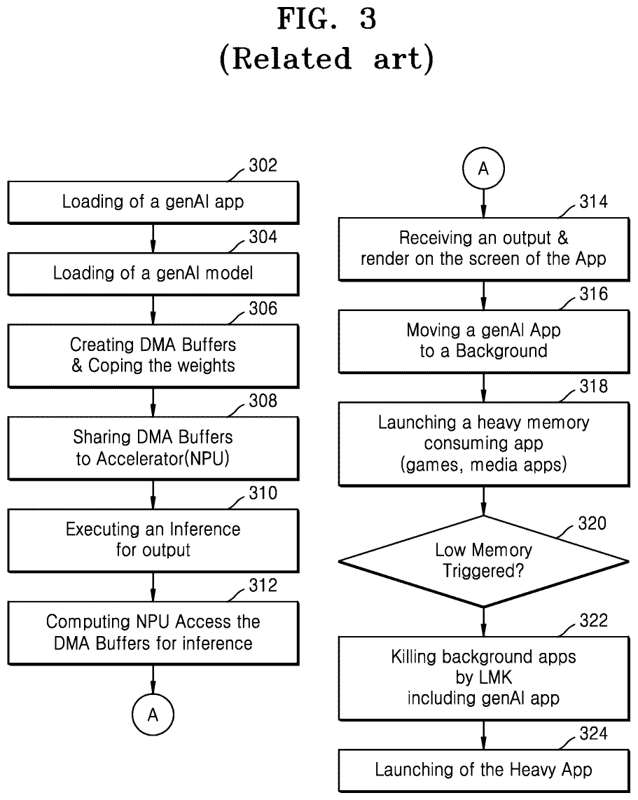

FIG. 3 is a flow diagram that illustrates a scenario where a GenAI model is loaded in a memory according to the related art. The flow diagram includes steps (302-324). At step (302), the GenAI application is loaded on the electronic device (100). When a user clicks on a GenAI icon in the GenAI application, a request is sent to a GenAI Core to load the GenAI model. At step (304), the GenAI model is loaded upon loading of the GenAI application on the electronic device (100). The DMA buffers are created and model weights are copied to the DMA Buffers. Gen AI Models are usually very large occupying 3-5 GB of memory space.

At step (306), the DMA buffers are created and their weights are accordingly copied. At step (308), the DMA buffers are shared the NPU (108B). At step (310), when the user clicks a specific GenAI task (for example, writing style) an inference is executed on the user input text. At step (312), a NPU access for the DMA buffers is computed/determined. During the inference stage, the NPU (108D) accesses the model weight DMA Buffers and performs computations on input tokens to generate output tokens. At step (314), the GenAI application receives an output. This output is then rendered on a screen of the electronic device (100).

At step (316), the GenAI application is moved to a background. At step (318), a heavy memory consuming application is launched. During this time if any memory-intensive application (for example, camera) is launched, the system starts to terminate background processes including the Gen AI process to free up memory for the new application. At step (320), it is determined whether a low memory is triggered. At step (322), the GenAI application moved to the background is killed or terminated. Termination of the Gen AI process will result in loss of the process state. Upon re-launch of the process state, the Gen AI process will start from a fresh state. At step (324), the heavy application is then launched.

In the related art, as GenAI model parameters expand, the memory requirements will also rise. This makes it increasingly challenging to allocate and manage memory efficiently on mobile and low-end devices.

The proposed solution discloses a method and system for recovering and DMA buffers in a GenAI model. The proposed solution monitors the state of a GenAI model based on certain parameters. For instance, the parameters include active/inactive status, previous inference time, and usage patterns (e.g., user's usage patterns), to determine the appropriate timing for triggering the GAMS. This ensures efficient memory management by dynamically optimizing resource allocation based on the model's operational state and user behavior. Further, the proposed solution recovers the memory of a GenAI model without unloading it. This ensures efficient memory management while maintaining the state of the GenAI model. The proposed solution also automatically restores backed DMA buffers when consumers (CPU (108A)/NPU (108B)) access the DMA buffers. This ensures seamless buffer restoration and efficient memory management during consumer access.

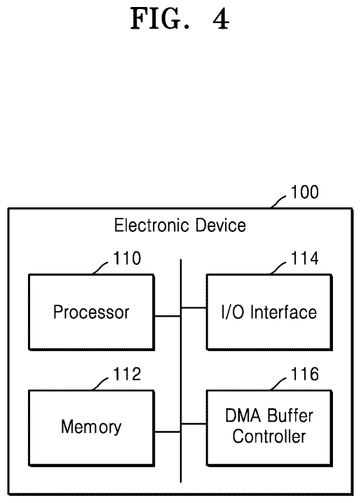

FIG. 4 is a block diagram that illustrates a schematic of the electronic device (100) implemented to carry out the disclosed subject matter according to an embodiment as disclosed herein. Examples of the electronic device (100) can include, but are not limited to, Consumer Electronics (such as Mobile Phones and Smartphones), Tablets, Wearable Devices, Computing Devices (such as Laptops, Notebooks, Desktops, Workstations, etc.), IoT Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), Media Devices (such as Gaming Consoles, Streaming Devices, etc.).

In an embodiment, in FIG. 4, the electronic device (100) includes a processor (110), a memory (112), an I/O interface (114), and a DMA buffer controller (116) coupled to the processor (110) and the memory (112). The components are explained in further detail below.

The processor (110) communicates with the memory (112), the I/O interface (114), and the DMA buffer controller (116). The processor (110) is configured to execute instructions stored in the memory (112) and to perform various processes. The processor (110) includes one or a plurality of processors, is a general-purpose processor such as the CPU (108A), an application processor (AP), or the like, a graphics-only processing unit such as a graphics processing unit (GPU), a visual processing unit (VPU), and/or an Artificial Intelligence (AI) dedicated processor such as a neural processing unit (NPU).

The memory (112) includes storage locations to be addressable through the processor (110). The memory (112) stores the state of the GenAI model, a trigger for the GAMS, and the like. The memory (112) is not limited to a volatile memory and/or a non-volatile memory. Further, the memory (112) includes a plurality of computer-readable storage media. The memory (112) includes non-volatile storage elements. For example, non-volatile storage elements include magnetic hard disks, optical disks, floppy disks, flash memories, or forms of electrically programmable memories (EPROM) or electrically erasable and programmable (EEPROM) memories.

The I/O interface (114) transmits the information between the memory (112) and external peripheral devices. The peripheral devices are the input-output devices associated with the electronic device (100). Further, the DMA buffer controller (116) communicates with the I/O interface (114) and the memory (112). The DMA buffer controller (116) is coupled to the memory (112) and the processor (110). This coupling allows for efficient data transfer and communication between the components, ensuring that the DMA buffer controller (116) can enable recovering and restoring of the DMA buffers in the GenAI model.

The DMA buffer controller (116) is an innovative integrated circuit that is implemented in the electronic device (100). In an embodiment, the structure of such innovative integrated circuit includes a multi-core architecture that enables recovering and restoring of the DMA buffers in the GenAI model. Each core is optimized for specific tasks, such as monitoring the state of the GenAI model, determining the DMA buffers that are safe for recovery, performing the GAMS memory recovery operation, performing the GAMS buffer restore operation, and the like. The innovative integrated circuit for the above-mentioned points is made of a combination of analog and digital components designed to enable recovering and restoring of the DMA buffers in the GenAI model. The analog components include a low-noise amplifier and a high-precision analog-to-digital converter to ensure accurate signal processing. The digital components consist of a microcontroller unit (MCU) and a digital signal processor (DSP) that work in tandem to enable recovering and restoring of the DMA buffers in the GenAI model.

In an embodiment, the DMA buffer controller (116) monitors a state of the GenAI model based on one or more parameters. For instance, the one or more parameters include a memory process state indicator (PSI) level of the GenAI model, the state of the GenAI model, a last inference time of the GenAI model, a usage pattern of the GenAI model, and the like. The memory PSI level refers to a time spent by the GenAI model in stalling/waiting due to memory pressure. A high memory PSI level indicates that the GenAI model is struggling to get enough memory, which can lead to inference delays, dropped requests, or degraded performance. The state of the GenAI model defines the operational status or current condition of the GenAI model. For example, the state can include active, loading, idle, unhealthy, and the like. The last interference time refers to a timestamp/time delta of the most recent inference the GenAI model performed. The usage pattern refers to observed trends indicating how and when the GenAI model is being used over time.

In an embodiment, the DMA buffer controller (116) determines a trigger for the GAMS based on the state of the GenAI model. The trigger is determined based on a trigger score. The DMA buffer controller (116) determines the trigger score based on the last inference time of the GenAI model, the usage pattern of the GenAI model, and the state of the GenAI model monitored. The DMA buffer controller (116) initiates the GAMS memory recovery operation if the trigger score is less than 0.5. Else, the DMA buffer controller (116) initiates the GAMS buffer restore operation if the trigger score is greater than 2. Further, the DMA buffer controller (116) triggers the GAMS memory recovery operation when the GenAI model is in the idle state.

In an embodiment, the DMA buffer controller (116) determines at least one buffer associated with the GenAI model that is safe for recovering upon triggering the GAMS. This ensures that only validated and non-compromised memory regions are involved in the recovery process, thereby maintaining the reliability of the GenAI model and minimizing the risk of propagating faulty or corrupted data. This buffer selection mechanism is essential for ensuring safe model execution continuity.

In an embodiment, the DMA buffer controller (116) filters each DMA buffer of the plurality of DMA buffers associated with the GenAI model according to a specified size threshold. Once filtered, the DMA buffer controller (116) generates a hash key for each DMA buffer during an initial loading of the GenAI model. The hash key generated is stored in the memory (114) of the electronic device (100). The hash key refers to a unique identifier generated by applying a hash function to the input data (DMA buffers).

In an embodiment, the DMA buffer controller (116) updates file descriptors associated with each DMA buffer during subsequence loading of the GenAI model. The file descriptions are updated based on a size of the DMA buffer and the hash key generated for the DMA buffer. The file descriptors refer to integer handles provided by to represent the DMA buffers in user spaces. These file descriptors allow applications (for example, like device drivers, user-space applications, or AI model runtimes) to access, share, or manage DMA memory regions efficiently.

In an embodiment, the DMA buffer controller (116) generates a second hash key for the DMA buffers during inference upon updating the file descriptors. The DMA buffer controller (116) then compares the second hash key for each DMA buffer with the hash key for each DMA buffer stored in the memory of the electronic device. This comparison is carried out to identify any differences between the two hash keys generated.

In an embodiment, the DMA buffer controller (116) determines the DMA buffer(s) that are safe for recovery if the hash key and the second hash key are the same. The second hash key is removed from the memory (114) of the electronic device (100) if the hash key and the second hash key are not the same.

In an embodiment, the DMA buffer controller (116) performs the GAMS memory recovery operation upon determining the DMA buffer(s) that is safe for recovery. The GAMS memory recovery operation is used to recover critical model data (weights, intermediate tensors, etc.) if inconsistencies or issues arise within the GenAI model. This is important for real-time inference, where downtime is unacceptable.

In an embodiment, the DMA buffer controller (116) retrieves file descriptors associated with the DMA buffers that are determined safe for recovery. Upon retrieval of the file descriptors, the DMA buffer controller (116) moves the file descriptors retrieved for the at least one DMA buffer to a NAND swap storage. The NAND swap storage refers to a technique or system where swap memory is stored on NAND flash storage (for example, eMMC, UFS, SSDs, etc.) instead of traditional RAM or disk-based swap.

In an embodiment, the DMA buffer controller (116) updates a memory management unit (MMU) and an input-output memory management unit (IOMMU) of the DMA buffers. These are updated to support the GAMS memory recovery operation when the file descriptors retrieved for the DMA buffer are moved to the NAND swap storage. The MMU handles the translation of virtual addresses to physical addresses. It allows each process to operate in its own virtual memory space. The IOMMU is used to translate device-generated addresses into physical memory addresses. Both the MMU and IOMMU are crucial for memory protection, isolation, and efficient buffer sharing. Updating the MMU and IOMMU of the DMA buffer allows one or more sub-systems to access the DMA buffer.

In an embodiment, the DMA buffer controller (116) performs an extension of the DMA buffers to obtain a plurality of new DMA buffers. The plurality of new DMA buffers supports the GAMS memory recovery operation when the one or more sub-systems access the plurality of new DMA buffers. Further, the new DMA buffers have a similar configuration and functionality as the original DMA buffers.

In an embodiment, the DMA buffer controller (116) performs the GAMS buffer restore operation using either the explicit restore operation and/or the implicit restore operation.

In the explicit restore operation, the DMA buffer controller (116) allocates a new memory region within the DMA buffers that are determined safe for recovery. The DMA buffer controller (116) then moves file descriptors of the DMA buffer stored in the NAND swap storage to the new memory region. The movement of file descriptors enables the DMA buffer controller (116) to restore direct memory access to critical data structures without reloading or reconstructing the original data. This thereby improves system resilience and minimizes downtime.

In an embodiment, the DMA buffer controller (116) updates the MMU and the IOMMU of the DMA buffers to support the GAMS buffer restore operation. This is updated when the file descriptors of the DMA buffers are moved into the new memory region. Updating the MMU and the IOMMU allows the DMA buffer to attach with the NPU (108B) for performing inferences. This allows the DMA buffer to function similarly prior to being moved to the NAND swap storage.

In an embodiment, in the implicit restore operation, the DMA buffer controller (116) receives a request from the NPU (108B) to establish an attachment with the DMA buffers for performing inferences. Upon receiving the request from the NPU (108B), a new memory region within the DMA buffers is allocated. File descriptors associated with the DMA buffers are then moved from the NAND swap device to the new memory region.

In an embodiment, the DMA buffer controller (116) updates the MMU and an IOMMU of the DMA buffers to support the GAMS buffer restore operation. This is updated when the file descriptors of the DMA buffer are moved into the new memory region. Updating the MMU and the IOMMU allows the DMA buffer to attach with the NPU (108B) for performing inferences. This allows the DMA buffer to function similarly prior to being moved to the NAND swap storage.

In an embodiment, the DMA buffer controller (116) performs a DMA buffer backup operation. The DMA buffer backup operation retains at least one of a context, a pipeline, and graphs associated with the GenAI model prior to allocation of the new memory region. The DMA buffer backup operation is performed without unloading a GenAI model and preserving an operational state of the GenAI model.

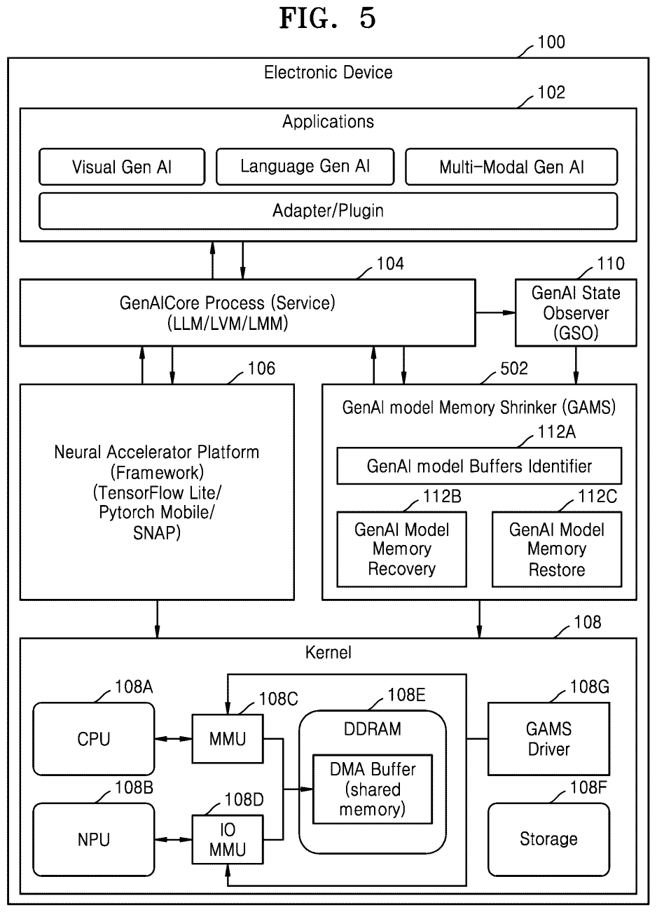

FIG. 5 is a block diagram that illustrates a high-level architecture of GenAI applications according to an embodiment as disclosed herein. As shown, the block diagram includes the electronic device (100) that includes applications (102), services (104), the framework (106), the kernel (108), a GenAI state observer (GSO) (110), and a GAMS (502). The applications (102) include visual GenAI, language GenAI, multi-model GenAI, an adapter/plugin, and the like. The services (104) correspond to GenAI core processes. The framework (106) corresponds to a neural accelerator platform. Further, the kernel (108) includes the CPU (108A), the NPU (108B), the MMU (108C), the IO MMU (108D), the DDRAM (108E), the storage (108F), and a GAMS driver (108G).

GenAI applications run at the CPU (108A) and model inference computations happen at the NPU (108B). To share the model memory across subsystem, model weights are loaded into the DMA buffers. The proposed method will recover memory of the DMA buffers when not in use and restore faster when required without impacting the user experience. The DMA buffers are widely in the electronic device (100) by different frameworks to interact with different subsystems. Freeing of DMA buffer memory without impacting the use case is challenging. Thus, the proposed solution frees up the memory space of the DMA buffer without unloading the GenAI model or terminating the GenAI process. This ensures that the state of the GenAI model, which is crucial for efficient inferences.

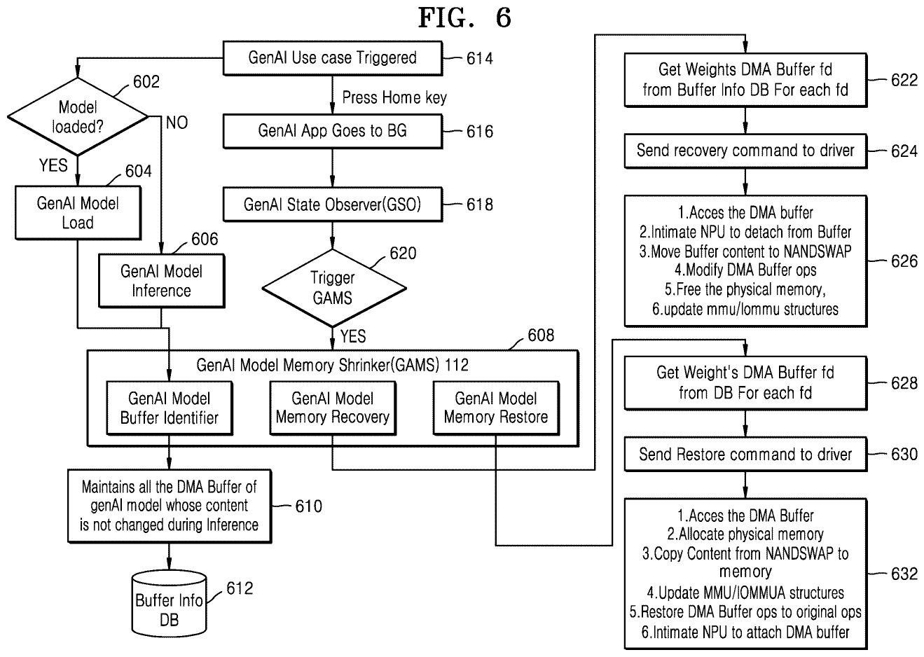

FIG. 6 is a flow diagram that illustrates a solution of recovering and restoring DMA buffers in the GenAI model according to an embodiment as disclosed herein. The flow diagram includes steps (602-632). At step (602), it is determined whether the GenAI model is loaded. If yes, then at step (604), the GenAI model is loaded on the electronic device (100). If no, then at step (606), the GenAI model inference is performed. At step (608), the loading of the GenAI model or the GenAI model inference information is passed to the GAMS (502). At step (610), the DMA buffers of the GenAI model whose content is not changed during inference is maintained. At step (612), this information is stored.

At step (614), a GenAI use case is triggered on a GenAI application on the electronic device (100). At step (616), the GenAI application goes into the background. At step (618), the GSO (110) is implemented to trigger the GAMS (502) in step (620). At step (622), weights of the DMA buffers are fetched along with the file descriptors associated with the DMA buffer. At step (624), a recovery command is sent upon received the weights of the DMA buffers.

At step (626), the following steps are performed: The DMA buffer is accessed, the NPU (108B) is detached from the DMA buffer, the DMA buffer content is moved to the NAND swap storage, the DMA buffer ops is modified, the physical memory of the DMA buffers is freed, and the MMU and IOMMU structures are updated. At step (628), the GenAI model memory recovery of the GAMS (502) retrieves the file descriptors associated with the GenAI model, and shares a restore command to a driver at step (630). At step (632), the following steps are performed: The DMA buffer is accessed, physical memory is allocated, content is copied from the NAND swap storage to the DMA buffer, the MMU and IOMMU structures are updated once the content is copied to the DMA buffer, the DMA buffer is restored to its original ops, and the NPU (108B) attaches to the DMA buffer.

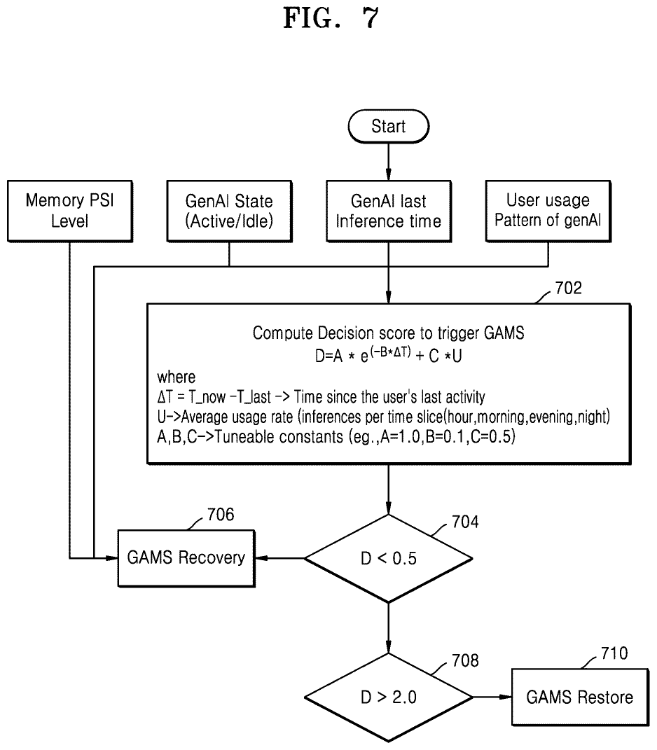

FIG. 7 is a flow diagram that illustrates operation of the GSO (110) according to an embodiment as disclosed herein. The flow diagram includes steps (702-710). At step (702), the decision score to trigger the GAMS (502) is predicted. The decision score is obtained based on parameters such as, memory process state indicator (PSI) level, GenAI state, GenAI last inference pattern, and usage pattern of the GenAI. The memory PSI level is a metric used to assess the operational state of the GenAI model. It is used to measure memory pressure of the GenAI model as it is combination of resource utilisation, latency, workload demands. The GenAI state represent the GenAI model memory state. Active state indicates that the GenAI model memory is not backed up. Idle state indicates that the GenAI model memory is back up. The GenAI last inference time indicates last inference time performed by the GenAI model. The GenAI usage pattern indicates an average GenAI usage rate per time slice by the user. For instance, the time slice can be categorised as morning, afternoon, evening, and night. Morning time slice: 6 am to 12 noon, Afternoon time slice: 12 noon to 6 μm, Evening time slice: 6 μm to 12 am, Night time slice: 12 am to 6 am.

The GSO (110) observes the the GenAI state, last inference time and user's usage pattern. The GSO (110) computes a score (D) with below formula

$$D = A * {e}^{\{ - B * Δ T \}} + C * U$$

Where ΔT=T now−T_last->Time since the user's last activity
U->Average usage rate [inferences per slot (morning, evening, night)
A, B, C->Tuneable constants (e.g., A=1.0, B=0.1, C=0.5)

At step (704), the GSO (110) checks whether the score (D) is below 0.5. If yes, then at step (706), a GAMS recovery operation is performed. At step (708), the GSO (110) checks if the score (D) is greater than 2. If yes, then at step (710), a GAMS restore operation is performed. For example, if ΔT=2 and average usage is 8 times per slot

D=1.0*e\hat{ }(−0.5*2)+0.25*8=2.37, (>2trigger the GAMS (502) with restore, <0.5 with recovery)

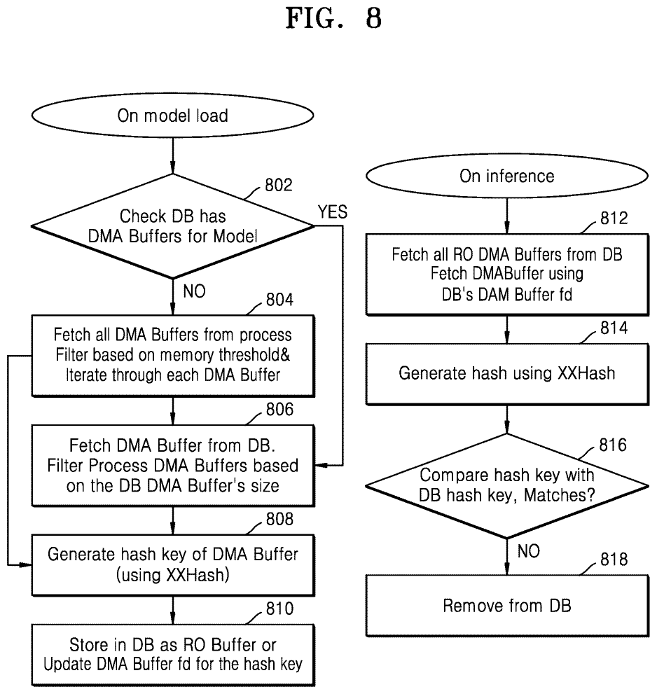

FIG. 8 is a flow diagram that illustrates identification of DMA buffers safe for recovery using the GAMS (502) according to an embodiment as disclosed herein. The flow diagram includes steps (802-818). At step (802), it is checked whether the database has DMA buffers for the GenAI model. If no, then at step (804), the DMA buffers are fetched by filtering based on a memory threshold (for example, 10 MB). If yes, then at step (806), the DMA buffers are fetched by filtering based on a buffer size of the DMA buffer.

At step (808), a hash key is generated for the DMA buffers fetched in step (804) or step (806). The hash key is generated only once during loading of the GenAI model. At step (810), the hash key is stored as a RO buffer or the file descriptors of the DMA buffer are updated corresponding to the hash key. At step (812), during inference, the RO buffers are fetched using the file descriptors of the DMA buffer. At step (814), a second hash key or DB hash key is generated. At step (816), the DB hash key is compared with the hash key generated at step (808). At step (818), if there is no match between the DB hash key and the hash key, then the DB hash key is removed from the database. This ensures that the database will have DMA buffers suitable for recovery.

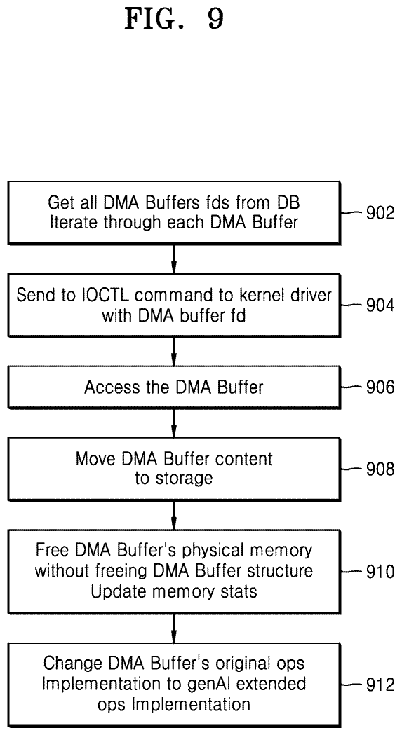

FIG. 9 is a flow diagram that illustrates a DMA buffer recovery operation using the GAMS (502) according to an embodiment as disclosed herein. The flow chart includes steps (902-912). At step (902), the file descriptors of the DMA buffers are fetched from the database. This process is iterated for each DMA buffer of the plurality of DMA buffers. At step (904), an IOCTL command is shared to a kernel driver including the file descriptors of the DMA buffers. At step (906), the DMA buffer is accessed using the file descriptors. At step (908), the content present within or associated with the DMA buffer is moved to the NAND swap storage. At step (910), the physical memory of the DMA buffer is freed. The DMA buffer structure is retained so that sub-systems like the CPU (108A)/NPU (108B)/GPU can still access the DMA buffer. This step will increase free memory. The MMU/IOMMU structures to support the DMA buffer recovery and restore operations are updated. At step (912), the operation functions of the original DMA buffer functions are extended to new DMA buffer functions to support restoration if sub-systems access the DMA buffer.

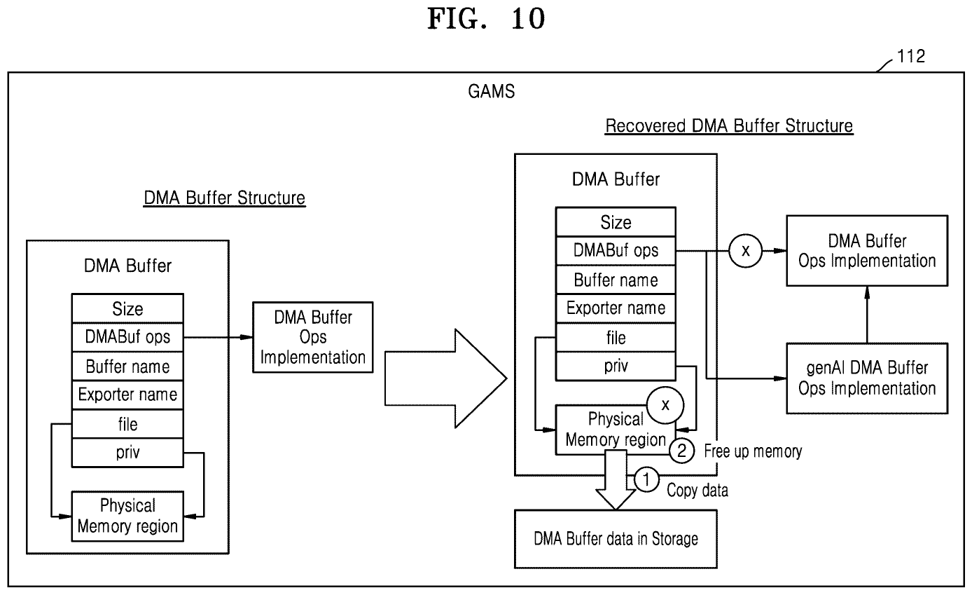

FIG. 10 is a block diagram that illustrates the DMA buffer recovery operation using the GAMS (502) according to an embodiment as disclosed herein. The DMA buffer contents are transferred to the NAND swap storage. The operations to implement GenAI operations are then adjusted. This adjustment is necessary to manage the restore function for the backed buffers. If any consumer (CPU (108A), NPU (108B)) accesses the backed DMA buffers, the modified GenAI DMA buffer operations will restore the buffer by allocating physical memory and transferring the buffer content from NAND swap to the RAM.

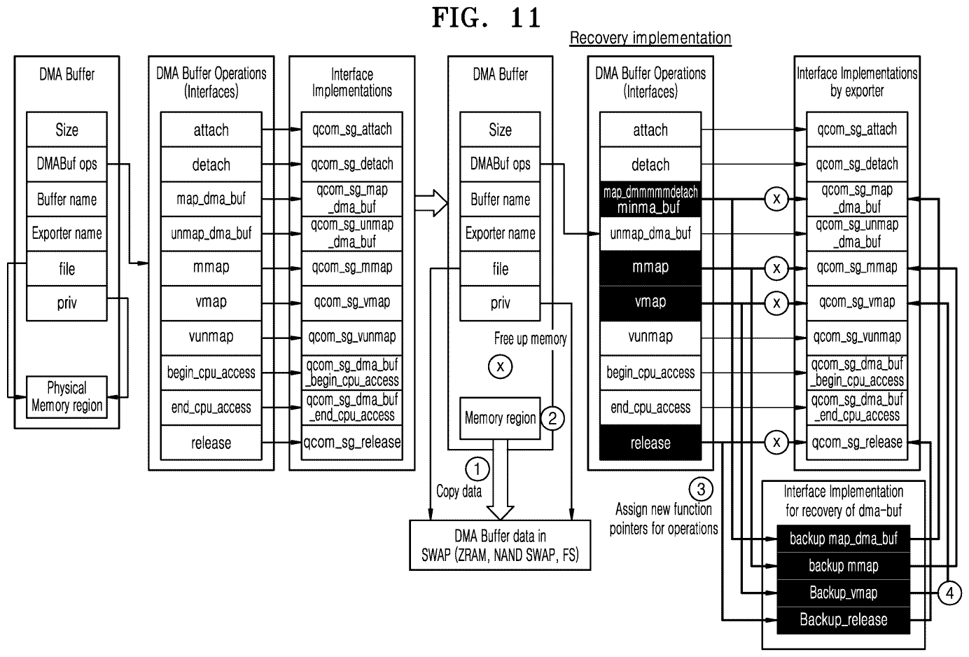

FIG. 11 is a block diagram that illustrates implementation details of the DMA buffer recovery operation using the GAMS (502) according to an embodiment as disclosed herein. The block diagram illustrates the DMA buffer structure along with the recovery implantation of the DMA buffer. The DMA Buffer includes various attributes such as Size, DMABuf ops, Buffer name, Exporter name, file, and priv. The DMA Buffer is linked to a Physical Memory region.

The DMA Buffer Operations (Interfaces) block includes several operations such as attach, detach, map_dma_buf, unmap_dma_buf, mmap, vmap, vunmap, begin_cpu_access, end_cpu_access, and release. These operations are implemented by corresponding functions in the Interface Implementations block. The Interface Implementations block contains original implementations for each operation, specifically orig_attach_impl, orig_detach_impl, orig_map_dma_buf_impl, orig_unmap_dma_buf_impl, orig_mmap_impl, orig_vmap_impl, orig_vunmap_impl, orig_begin_cpu_access_impl, orig_end_cpu_access_impl, and orig_release_impl.

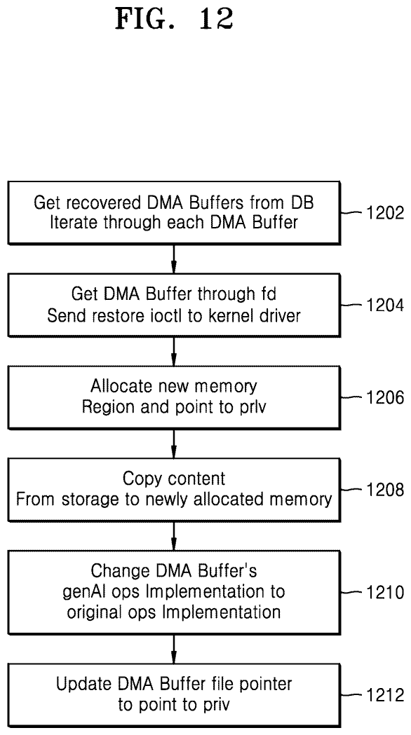

FIG. 12 is a flow diagram that illustrates an explicit method for performing the GAMS (502) according to an embodiment as disclosed herein. The flow diagram includes steps (1202-1212). At operation (1202), all file descriptors of the DMA buffers are retrieved from the database that have already been backed up. This process is iterated for each DMA buffer of the plurality of DMA buffers. At step (1204), the DMA buffer object is accessed using its file descriptor. At step (1206), a new memory is allocated by adjusting a private member to reference the newly allocated area. At step (1208), the contents of the DMA buffer stored in NAND swap is transferred to the newly allocated memory. At step (1210), the recovered DMA buffer's operations is modified to reflect the original operations implementation. The MMU and IOMMU structures associated with the DMA buffer are updated to facilitate the DMA buffer restoration process. At step (1212), the DMA buffer file pointer is updated to point to the private member.

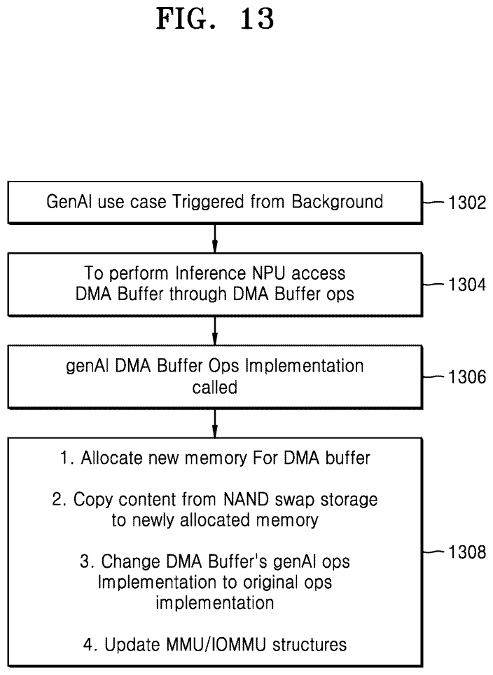

FIG. 13 is a flow diagram that illustrates an implicit method for performing the GAMS (502) according to an embodiment as disclosed herein. The flow diagram includes steps (1302-1308). At step (1302), the GenAI use case is triggered by the application in the background. At step (1304), an inference is performed once the NPU (108B) accesses the DMA buffer. The operations for the DMA buffer are invoked when the NPU (108B) accesses the DMA buffer, as the implementation of DMA buffer operations is modified to reflect the recovered DMA buffer operations during the recovery process. At step (1306), the operation implementation of the DMA buffer is called. At step (1308), the following steps are performed: a new memory is allocated for the DMA buffer, content is copied from the NAND swap storage to the newly allocated memory, the operation implementation of the DMA buffer is changed to its original implementation, and the MMU and IO MMU structures are updated once the operation implementation of the DMA buffer is changed.

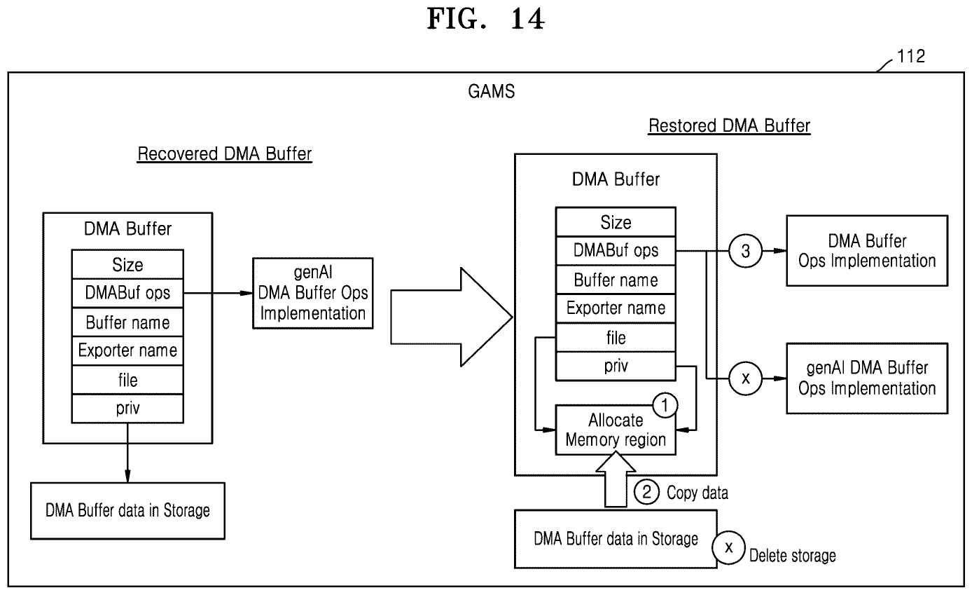

FIG. 14 is a block diagram that illustrates the GAMS (502) using the implicit method and the explicit method according to an embodiment as disclosed herein. The DMA buffer allocates a new memory region (physical memory). Content is then transferred from the NAND swap to the new memory region. The DMA buffer operations are then adjusted to match the original DMA buffer operations implementation. This step will guarantee that the restored DMA buffer functions identically to the original DMA buffer.

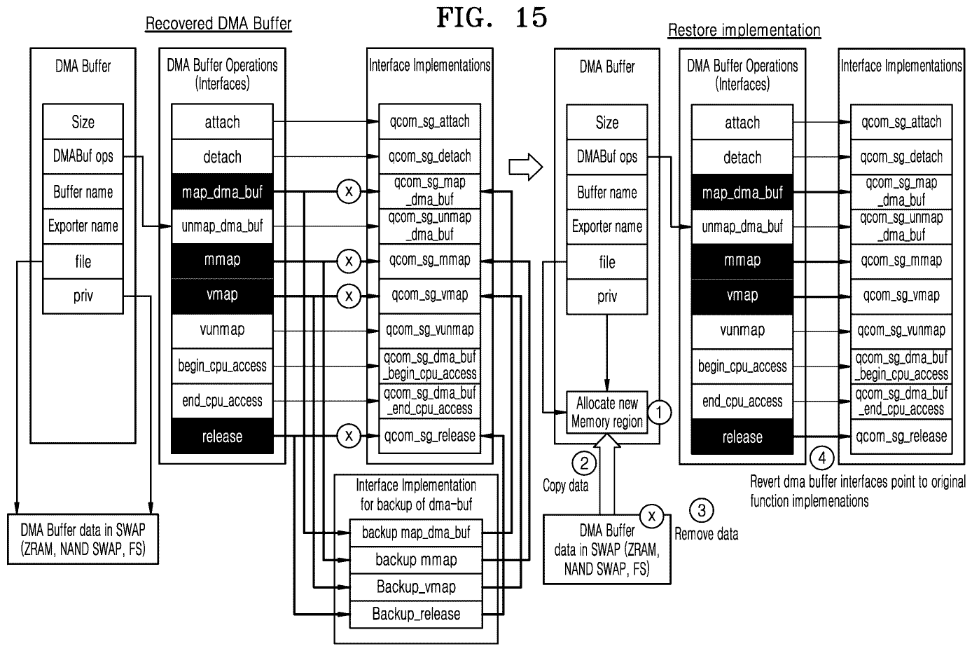

FIG. 15 is a block diagram that illustrates implementation details of the GAMS (502) using the implicit method and the explicit method according to an embodiment as disclosed herein. The block diagram illustrates the DMA buffer structure along with the restore implementation of the DMA buffer. Restore operation will change DMA Buffer operations to point to original interface implementation functions instead of backup implementation functions.

The block diagram shown in FIG. 15 enhances the existing backup operation by introducing new implementations for DMA Buffer operations, copying data to a SWAP area, freeing up memory, and modifying function pointers to utilize backup implementations. This results in a more efficient and reliable backup process.

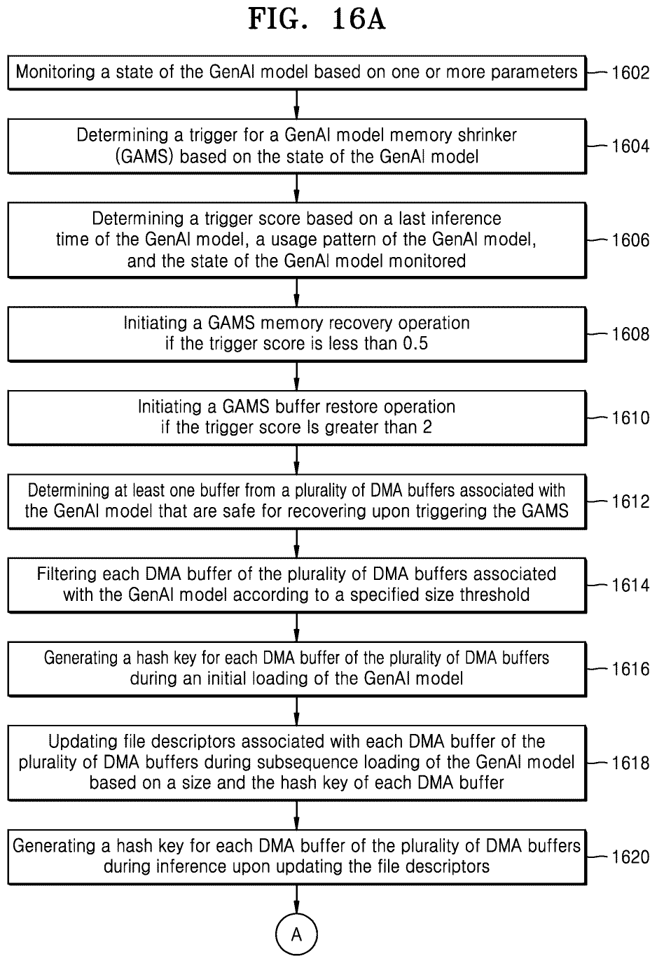

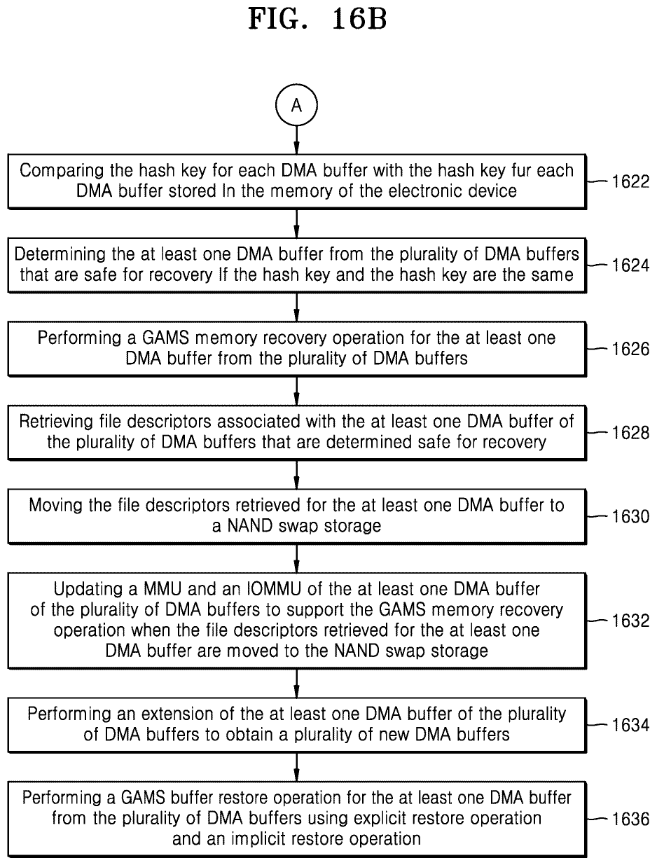

FIGS. 16A-B are flow diagrams that illustrates a method for recovering and restoring DMA buffers in the GenAI model according to an embodiment as disclosed herein. The method includes steps (1602-1636). Each step is explained in further detail below.

At step (1602), the electronic device (100) monitors a state of the GenAI model based on one or more parameters. For instance, the one or more parameters include a memory PSI level of the GenAI model, the state of the GenAI model, a last inference time of the GenAI model, a usage pattern of the GenAI model, and the like. The memory PSI level refers to a time spent by the GenAI model in stalling/waiting due to memory pressure. A high memory PSI level indicates that the GenAI model is struggling to get enough memory, which can lead to inference delays, dropped requests, or degraded performance. The state of the GenAI model defines the operational status or current condition of the GenAI model. For example, the state can include active, loading, idle, unhealthy, and the like. The last interference time refers to a timestamp/time delta of the most recent inference the GenAI model performed. The usage pattern refers to observed trends indicating how and when the GenAI model is being used over time.

At step (1604), the electronic device (100) determines a trigger for the GAMS (502) based on the state of the GenAI model. The trigger is determined based on a trigger score. At step (1606), the electronic device (100) determines the trigger score based on the last inference time of the GenAI model, the usage pattern of the GenAI model, and the state of the GenAI model monitored. At step (1608), the electronic device (100) initiates the GAMS (502) memory recovery operation if the trigger score is less than 0.5. Else, at step (1610), the electronic device (100) initiates the GAMS buffer restore operation if the trigger score is greater than 2. Further, the DMA buffer controller (116) triggers the GAMS memory recovery operation when the GenAI model is in the idle state.

At step (1612), the electronic device (100) determines at least one buffer associated with the GenAI model that is safe for recovering upon triggering the GAMS (502). This ensures that only validated and non-compromised memory regions are involved in the recovery process, thereby maintaining the reliability of the GenAI model and minimizing the risk of propagating faulty or corrupted data. This buffer selection mechanism is essential for ensuring safe model execution continuity.

At step (1614), the electronic device (100) filters each DMA buffer of the plurality of DMA buffers associated with the GenAI model according to a specified size threshold. Once filtered, at step (1616), the electronic device (100) generates a hash key for each DMA buffer during an initial loading of the GenAI model. The hash key generated is stored in the memory (114) of the electronic device (100). The hash key refers to a unique identifier generated by applying a hash function to the input data (DMA buffers).

At step (1618), the electronic device (100) updates file descriptors associated with each DMA buffer during subsequence loading of the GenAI model. The file descriptions are updated based on a size of the DMA buffer and the hash key generated for the DMA buffer. The file descriptors refer to integer handles provided by to represent the DMA buffers in user spaces. These file descriptors allow applications (for example, like device drivers, user-space applications, or AI model runtimes) to access, share, or manage DMA memory regions efficiently.

At step (1620), the electronic device (100) generates a second hash key for the DMA buffers during inference upon updating the file descriptors. At step (1622), the electronic device (100) then compares the second hash key for each DMA buffer with the hash key for each DMA buffer stored in the memory of the electronic device. This comparison is carried out to identify any differences between the two hash keys generated.

At step (1624), the electronic device (100) determines the DMA buffer(s) that are safe for recovery if the hash key and the second hash key are the same. The second hash key is removed from the memory (114) of the electronic device (100) if the hash key and the second hash key are not the same.

At step (1626), the electronic device (100) performs the GAMS memory recovery operation upon determining the DMA buffer(s) that is safe for recovery. The GAMS memory recovery operation is used to recover critical model data (weights, intermediate tensors, etc.) if inconsistencies or issues arise within the GenAI model. This is important for real-time inference, where downtime is unacceptable.

At step (1628), the electronic device (100) retrieves file descriptors associated with the DMA buffers that are determined safe for recovery. This acquisition is crucial as it ensures that the buffer being backed up is the one initially created and shared by the responsible method. The file descriptor acts as a unique identifier, enabling the system to accurately locate and reference the correct DMA buffer, thereby laying the foundation for subsequent operations.

Upon retrieval of the file descriptors, at step (1630), the electronic device (100) moves the file descriptors retrieved for the at least one DMA buffer to a NAND swap storage. The NAND swap storage refers to a technique or system where swap memory is stored on NAND flash storage (for example, eMMC, UFS, SSDs, etc.) instead of traditional RAM or disk-based swap. This transfer is essential for optimizing memory usage and ensuring that the system can efficiently manage its resources. By moving the content to the NAND swap storage, the system can free up physical memory, making it available for other processes and operations. This step is a key aspect of the backup operation, allowing the system to maintain a backup of the DMA buffer's content while simultaneously optimizing memory usage.

At step (1632), the electronic device (100) updates the MMU and the IOMMU of the DMA buffers. These are updated to support the GAMS memory recovery operation when the file descriptors retrieved for the DMA buffer are moved to the NAND swap storage. The MMU handles the translation of virtual addresses to physical addresses. It allows each process to operate in its own virtual memory space. The IOMMU is used to translate device-generated addresses into physical memory addresses. Both the MMU and IOMMU are crucial for memory protection, isolation, and efficient buffer sharing. Updating the MMU and IOMMU of the DMA buffer allows one or more sub-systems to access the DMA buffer.

At step (1634), the electronic device (100) performs an extension of the DMA buffers to obtain a plurality of new DMA buffers. The plurality of new DMA buffers supports the GAMS memory recovery operation when the one or more sub-systems access the plurality of new DMA buffers. Further, the new DMA buffers have a similar configuration and functionality as the original DMA buffers.

At step (1636), the electronic device (100) performs the GAMS buffer restore operation using either the explicit restore operation or the implicit restore operation.

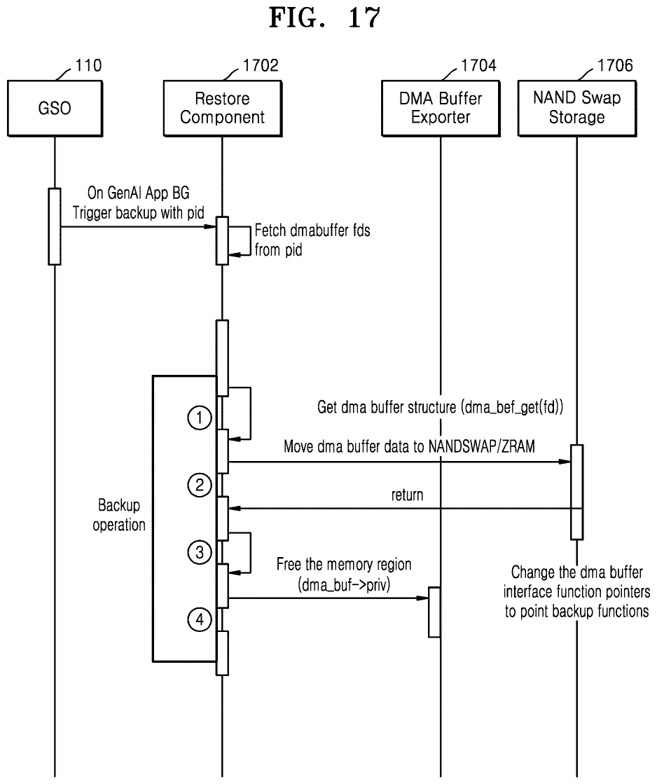

FIG. 17 is a sequence diagram that illustrates a backup trigger use case according to an embodiment as disclosed herein. As shown in the sequence diagram, the GSO (110), a restore component (1702), a DMA buffer exporter (1704), and a NAND swap storage (1706) are in communication with each other. Each step is explained in further detail below. In an embodiment, the GSO (110) sends an on-GenAI App BG trigger backup with a method ID (pid) to the restore component (1702). The restore component (1702) then fetches DMA buffer file descriptors (fds) from the pid and initiates the backup operation, which includes four steps. At step 1, the restore component (1702) retrieves the DMA buffer structure (dma_buf_get(fd)). At step 2, the restore component (1702) moves the DMA buffer to the NAND swap storage (1706)/ZRSAM. At step 3, the NAND swap storage (1706) changes the DMA buffer interface function pointers to point to backup functions and returns it to the restore component (1702). At step 4, the restore component (1702) frees the memory region (dma_buf->priv) in the system heap DMA buffer exporter.

The backup process is designed to ensure data integrity and efficient memory management. By transferring the DMA buffer to the NAND swap storage (1702), the system leverages high-speed non-volatile memory to store critical data. This method not only accelerates the backup process but also minimizes the risk of data loss during power failures or system crashes. The reconfiguration of DMA buffer interface function pointers to backup functions allows the system to seamlessly redirect data operations to the backup storage, ensuring that the restore component (1702) can efficiently manage and free up system resources.

Furthermore, the use of the system heap DMA buffer exporter to free the memory region (dma_buf->priv) optimizes memory usage within the system. This maintains system performance, as it prevents memory leaks and ensures that the system heap remains available for other processes. The entire sequence is designed to be transparent to the user, providing a seamless backup experience that enhances the reliability and robustness of the application.

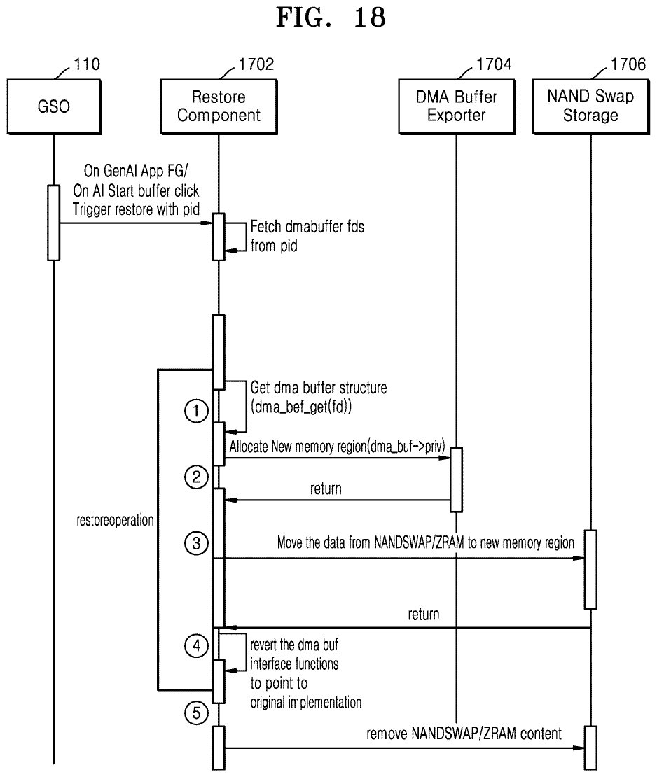

FIG. 18 is a sequence diagram that illustrates a restore trigger use case according to an embodiment as disclosed herein. As shown in the sequence diagram, the GSO (110), the restore component (1702), the DMA buffer exporter (1704), and the NAND swap storage (1706) are in communication with each other. Each step is explained in further detail below. In an embodiment, the GSO (110) sends an on-GenAI App FG/On AI start button click trigger restore with pid to the restore module. The restore component (1702) then fetches DMA buffer fds from the pid and initiates the restore operation, which includes five steps. At step 1, the restore component (1702) retrieves the DMA buffer structure (dma_buf_get(fd)). At step 2, the restore component (1702) allocates a new memory region (dma_buf->priv) in the system heap DMA buffer exporter. At step 3, the data is moved from NANDSWAP/ZRSAM to the new memory region. At step 4, the DMA buffer interface functions are reverted to point to the original implementation. At step 5, the restore module removes the NANDSWAP/ZRSAM content.

The restore process is designed to reverse the backup operation efficiently and accurately. By allocating a new memory region in the system heap, the restore module ensures that there is sufficient space to accommodate the restored data. The movement of data from NAND swap storage (1706)/ZRSAM back to the new memory region is performed with high precision to maintain data integrity. Reverting the DMA buffer interface functions to their original implementation is a critical step that ensures the application can resume normal operations without any modifications to its core functionality.

Further, the removal of NAND swap storage (1706) content by the restore module ensures that the temporary backup storage is cleared, preventing any potential data redundancy or conflicts. The entire restore sequence is designed to be quick and reliable, providing users with a seamless transition back to their application's original state, thus enhancing user experience and trust in the system's reliability.

In an embodiment, the hint based mechanism without saving Virtual memory address:
a. recovery: The GenAI application will initiate a recovery operation, during which the GAMS (502) will save the complete content of the DMA buffer to a file. It will then request all client mapped to the DMA buffer to unmap it. Once the clients unmap, they will release the physical memory region without freeing the DMA buffer. Hence, the virtual memory address and the physical address of the memory region will be removed.
b. restore: The GenAI application will initiate a restore operation prior to the GenAI inference. The GAMS (502) will allocate a new memory region for the DMA Buffer and transfer the content from the stored file to the newly allocated memory. In this case, new virtual memory addresses and physical addresses are generated for the new memory region. As the client modules have already been unmapped during the recovery process, they will remap to access the DMA buffer and receive the new virtual memory address.

In an embodiment, the hint based mechanism with saving virtual memory address
a. recovery: The GenAI application will initiate the recovery operation, during which the GAMS (502) will store the complete content of the DMA buffer to a file and free up physical memory while keeping the DMA buffer intact. Thus, the client is not required to un-map the DMA buffer. In this case, the virtual memory address is preserved while the physical address is discarded.
b. restore: The GenAI application will initiate a restore operation prior to GenAI inference. The GAMS (502) will then allocate a new memory region for the DMA buffer, transferring the content from the stored file to the newly allocated memory and mapping the new physical address to the existing virtual memory address. In this scenario, physical addresses for the new memory region are generated and mapped to the previous virtual memory address. All clients, such as NPU, refrain from accessing the DMA Buffer without completing the restore operation.

In an embodiment, Handling through page fault without any hints:
a. recovery: The GenAI application will initiate a recovery operation, during which the GAMS (502) will store the complete content of the DMA buffer to a file and free up physical memory while keeping the DMA buffer intact. Consequently, client is not required to unmap the DMA buffer. In this scenario, the virtual memory address is preserved while the physical address is discarded.
b. restore: The GenAI application will initiate GenAI inference, while the GAMS (502) will allocate a new memory region for the DMA Buffer. A person of skill in the art will know that use of “while” includes a partial or complete overlap in the initiation and the allocation operations. It will then copy the content from the stored file into the newly allocated memory and update the physical address in the MMU/SysMMU page tables. In this scenario, physical addresses for the new memory region are generated, and the MMU page tables are updated with the new physical address corresponding to the old virtual address. All clients have direct access to the backed DMA buffer. If the virtual memory address does not point to a valid physical address, the MMU will trigger a page fault interrupt, which resolves the issue by restoring the physical memory.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

In the first aspect of the disclosure, there is provided the method for recovering and restoring direct memory access (DMA) buffers associated with a generative artificial intelligence (GenAI) model by an electronic device, comprising obtaining, by the electronic device, a state of the GenAI model based on one or more parameters, determining, by the electronic device, a trigger for a GenAI model memory shrinker (GAMS) (502) based on the state of the GenAI model, determining, by the electronic device, at least one buffer from a plurality of DMA buffers associated with the GenAI model that are safe for recovering based on triggering the GAMS, executing, by the electronic device, a GAMS memory recovery operation for the at least one DMA buffer from the plurality of DMA buffers and executing, by the electronic device, a GAMS buffer restore operation for the at least one DMA buffer from the plurality of DMA buffers.

The GAMS buffer restore operation comprises at least one of an explicit restore operation and an implicit restore operation.

The one or more parameters comprises at least one of a memory process state indicator (PSI) level of the GenAI model, the state of the GenAI model, a last inference time of the GenAI model, and a usage pattern of the GenAI model.

Determining, by the electronic device, the trigger for the GAMS (502) based on the state of the GenAI model comprises determining, by the electronic device, a trigger score based on at least one of a last inference time of the GenAI model, a usage pattern of the GenAI model, and the state of the GenAI model, initiating, by the electronic device, a GAMS memory recovery operation based on the trigger score being less than 0.5 and initiating, by the electronic device, a GAMS buffer restore operation based on the trigger score being greater than 2.

The method comprises determining, by the electronic device, that a state of the GenAI model is an idle state and triggering, by the electronic device, the GAMS memory recovery operation when the GenAI model is in the idle state.

Determining, by the electronic device, the at least one buffer from the plurality of DMA buffers associated with the GenAI model that are safe for recovering comprises filtering, by the electronic device, each DMA buffer of the plurality of DMA buffers associated with the GenAI model based on a size threshold, generating, by the electronic device, a first hash key for each DMA buffer of the plurality of DMA buffers during an initial loading of the GenAI model, wherein the first hash key generated is stored in a memory of the electronic device, updating, by the electronic device, file descriptors associated with each DMA buffer of the plurality of DMA buffers during loading of the GenAI model based on a size and the hash key of each DMA buffer, generating, by the electronic device, a second hash key for each DMA buffer of the plurality of DMA buffers during inference subsequent to updating the file descriptors, comparing, by the electronic device, the second hash key for each DMA buffer with the first hash key for each DMA buffer and based on at least one hash key being same, determining, by the electronic device, that the at least one DMA buffer from the plurality of DMA buffers associated with the at least one hash key are safe for recovery, wherein one or more hash keys that are not the same are removed from the memory of the electronic device.

Executing, by the electronic device, the GAMS memory recovery operation for the at least one DMA buffer from the plurality of DMA buffers comprises retrieving, by the electronic device, file descriptors associated with the at least one DMA buffer of the plurality of DMA buffers that are determined safe for recovery, wherein the file descriptors are stored in a memory of the electronic device, moving, by the electronic device, the file descriptors retrieved for the at least one DMA buffer to a NAND swap storage, updating, by the electronic device, a memory management unit (MMU) and an input-output memory management unit (IOMMU) of the at least one DMA buffer of the plurality of DMA buffers to support the GAMS memory recovery operation based on the file descriptors retrieved for the at least one DMA buffer being moved to the NAND swap storage and performing, by the electronic device, an extension of the at least one DMA buffer of the plurality of DMA buffers to obtain a plurality of new DMA buffers.

Updating the MMU and IOMMU of the at least one DMA buffer allows one or more sub-systems to access the at least one DMA buffer, wherein the plurality of new DMA buffers supports the GAMS memory recovery operation when the one or more sub-systems access the plurality of new DMA buffers, and wherein the one or more sub-systems comprise at least one of a central processing unit (CPU) (108A), a neural processing unit (NPU) (108B), and a graphics processing unit (GPU).

Executing, by the electronic device, the explicit restore operation comprises allocating, by the electronic device, a new memory region within the at least one DMA buffer of the plurality of DMA buffers that are determined safe for recovery, moving, by the electronic device, file descriptors of the at least one DMA buffer stored in a NAND swap storage to the new memory region and updating, by the electronic device, a MMU and an IOMMU of the at least one DMA buffer of the plurality of DMA buffers to support the GAMS buffer restore operation based on the file descriptors of the at least one DMA buffer being moved into the new memory region, wherein the at least one DMA buffer is allowed to attach with a NPU for performing inferences based on the updating the MMU and the IOMMU.

Executing, by the electronic device, the implicit restore operation comprises receiving, by the electronic device, a request from a NPU to establish an attachment with at least one DMA buffer of the plurality of DMA buffers for performing inferences, allocating, by the electronic device, a new memory region within the at least one DMA buffer of the plurality of DMA buffers based on receiving the request from the NPU that are determined safe for recovery, moving, by the electronic device, file descriptors of the at least one DMA buffer stored in a NAND swap storage to the new memory region and updating, by the electronic device, a MMU and an IOMMU of the at least one DMA buffer of the plurality of DMA buffers to support the GAMS buffer restore operation based on the file descriptors of the at least one DMA buffer being moved into the new memory region, wherein the at least one DMA buffer is allowed to attach with the NPU based on the updating the MMU and the IOMMU.

The method comprises executing, by the electronic device, a DMA buffer backup operation, wherein the DMA buffer backup operation retains at least one of a context, a pipeline, and graphs associated with the GenAI model prior to allocation of the new memory region within the at least one DMA buffer of the plurality of DMA buffers, wherein the DMA buffer backup operation is executed without unloading a GenAI model, and wherein the execution of the DMA buffer backup operation preserves an operational state of the GenAI model.

The method comprises detecting, by the electronic device, at least one of a recovery operation and a restore operation associated with a GenAI application, performing, by the electronic device, one of storing, by the electronic device, contents associated with the plurality of DMA buffers in a file releasing a physical memory region associated with the DMA buffer while maintaining buffer metadata, based on the recovery operation being triggered and allocating, by the electronic device, a new physical memory region for the plurality of DMA buffers by restoring contents from the file to the new physical memory region based on the restore operation being triggered.

One or more clients access the plurality of DMA buffers through at least one virtual memory address, and wherein the recovery operation comprises storing the at least one virtual memory address of the plurality of DMA buffers while releasing the new physical memory region, and wherein the restore operation comprises mapping the new physical memory region to the at least one virtual memory address providing one or more clients access to the plurality of DMA buffers without remapping.

The restore operation is deferred to be subsequent to the one or more clients attempting to access the plurality of DMA buffers through the at least one virtual memory address not mapped to the physical memory region.

The method comprises generating, by the electronic device, a page fault interrupt when the one or more clients access the plurality of DMA buffers, handling, by the electronic device, the page fault interrupt by allocating the a new physical memory region, restoring the contents of associated with the plurality of DMA buffers, and updating page tables to associate the a virtual memory address with the new physical memory region.

An electronic device for recovering and restoring DMA buffers associated with a GenAI model, comprising at least one processor, memory coupled to the at least one processor and a DMA buffer controller communicatively coupled to the at least one processor and the memory, wherein the DMA buffer controller is configured to obtain a state of the GenAI model based on one or more parameters, determine a trigger for a GenAI model memory shrinker (GAMS) (502) based on the state of the GenAI model, determine at least one buffer from a plurality of DMA buffers associated with the GenAI model that are safe for recovering based on triggering the GAMS (502), execute a GAMS memory recovery operation for the at least one DMA buffer from the plurality of DMA buffers and execute a GAMS buffer restore operation for the at least one DMA buffer from the plurality of DMA buffers, wherein the GAMS buffer restore operation comprises an explicit restore operation and an implicit restore operation.

A non-transitory computer readable medium storing instructions for recovering and restoring direct memory access (DMA) buffers associated with a generative artificial intelligence (GenAI) model, the instructions that when executed by at least one processor of an electronic device cause the electronic device to obtain a state of the GenAI model based on one or more parameters, determine a trigger for a GenAI model memory shrinker (GAMS) based on the state of the GenAI model, determine at least one buffer from a plurality of DMA buffers associated with the GenAI model that are safe for recovering based on triggering the GAMS, execute a GAMS memory recovery operation for the at least one DMA buffer from the plurality of DMA buffers and execute a GAMS buffer restore operation for the at least one DMA buffer from the plurality of DMA buffers.

What is claimed is:

1. A method for recovering and restoring direct memory access (DMA) buffers associated with a generative artificial intelligence (GenAI) model by an electronic device, comprising:
obtaining, by the electronic device, a state of the GenAI model based on one or more parameters;
determining, by the electronic device, a trigger for a GenAI model memory shrinker (GAMS) based on the state of the GenAI model;
determining, by the electronic device, at least one buffer from a plurality of DMA buffers associated with the GenAI model that are safe for recovering based on triggering the GAMS;
executing, by the electronic device, a GAMS memory recovery operation for the at least one DMA buffer from the plurality of DMA buffers; and
executing, by the electronic device, a GAMS buffer restore operation for the at least one DMA buffer from the plurality of DMA buffers.

2. The method as claimed in claim 1, wherein the GAMS buffer restore operation comprises at least one of an explicit restore operation and an implicit restore operation.

3. The method as claimed in claim 1, wherein the one or more parameters comprises at least one of a memory process state indicator (PSI) level of the GenAI model, the state of the GenAI model, a last inference time of the GenAI model, and a usage pattern of the GenAI model.

4. The method as claimed in claim 1, wherein determining, by the electronic device, the trigger for the GAMS based on the state of the GenAI model comprises:
determining, by the electronic device, a trigger score based on at least one of a last inference time of the GenAI model, a usage pattern of the GenAI model, and the state of the GenAI model;
initiating, by the electronic device, a GAMS memory recovery operation based on the trigger score being less than 0.5; and
initiating, by the electronic device, a GAMS buffer restore operation based on the trigger score being greater than 2.

5. The method as claimed in claim 4, comprising:
determining, by the electronic device, that a state of the GenAI model is an idle state; and
triggering, by the electronic device, the GAMS memory recovery operation when the GenAI model is in the idle state.

6. The method as claimed in claim 1, wherein determining, by the electronic device, the at least one buffer from the plurality of DMA buffers associated with the GenAI model that are safe for recovering comprises:
filtering, by the electronic device, each DMA buffer of the plurality of DMA buffers associated with the GenAI model based on a size threshold;
generating, by the electronic device, a first hash key for each DMA buffer of the plurality of DMA buffers during an initial loading of the GenAI model, wherein the first hash key generated is stored in a memory of the electronic device;
updating, by the electronic device, file descriptors associated with each DMA buffer of the plurality of DMA buffers during loading of the GenAI model based on a size and the hash key of each DMA buffer;
generating, by the electronic device, a second hash key for each DMA buffer of the plurality of DMA buffers during inference subsequent to updating the file descriptors;
comparing, by the electronic device, the second hash key for each DMA buffer with the first hash key for each DMA buffer; and
based on at least one hash key being same, determining, by the electronic device, that the at least one DMA buffer from the plurality of DMA buffers associated with the at least one hash key are safe for recovery, wherein one or more hash keys that are not the same are removed from the memory of the electronic device.

7. The method as claimed in claim 1, wherein executing, by the electronic device, the GAMS memory recovery operation for the at least one DMA buffer from the plurality of DMA buffers comprises:
retrieving, by the electronic device, file descriptors associated with the at least one DMA buffer of the plurality of DMA buffers that are determined safe for recovery, wherein the file descriptors are stored in a memory of the electronic device;
moving, by the electronic device, the file descriptors retrieved for the at least one DMA buffer to a NAND swap storage;
updating, by the electronic device, a memory management unit (MMU) and an input-output memory management unit (IOMMU) of the at least one DMA buffer of the plurality of DMA buffers to support the GAMS memory recovery operation based on the file descriptors retrieved for the at least one DMA buffer being moved to the NAND swap storage; and
performing, by the electronic device, an extension of the at least one DMA buffer of the plurality of DMA buffers to obtain a plurality of new DMA buffers.

8. The method as claimed in claim 7, wherein updating the MMU and IOMMU of the at least one DMA buffer allows one or more sub-systems to access the at least one DMA buffer, wherein the plurality of new DMA buffers supports the GAMS memory recovery operation when the one or more sub-systems access the plurality of new DMA buffers, and wherein the one or more sub-systems comprise at least one of a central processing unit (CPU) (108A), a neural processing unit (NPU) (108B), and a graphics processing unit (GPU).

9. The method as claimed in claim 2, wherein executing, by the electronic device, the explicit restore operation comprises:
allocating, by the electronic device, a new memory region within the at least one DMA buffer of the plurality of DMA buffers that are determined safe for recovery;
moving, by the electronic device, file descriptors of the at least one DMA buffer stored in a NAND swap storage to the new memory region; and
updating, by the electronic device, a MMU and an IOMMU of the at least one DMA buffer of the plurality of DMA buffers to support the GAMS buffer restore operation based on the file descriptors of the at least one DMA buffer being moved into the new memory region,
wherein the at least one DMA buffer is allowed to attach with a NPU for performing inferences based on the updating the MMU and the IOMMU.

10. The method as claimed in claim 2, wherein executing, by the electronic device, the implicit restore operation comprises:
receiving, by the electronic device, a request from a NPU to establish an attachment with at least one DMA buffer of the plurality of DMA buffers for performing inferences;
allocating, by the electronic device, a new memory region within the at least one DMA buffer of the plurality of DMA buffers based on receiving the request from the NPU that are determined safe for recovery;
moving, by the electronic device, file descriptors of the at least one DMA buffer stored in a NAND swap storage to the new memory region; and
updating, by the electronic device, a MMU and an IOMMU of the at least one DMA buffer of the plurality of DMA buffers to support the GAMS buffer restore operation based on the file descriptors of the at least one DMA buffer being moved into the new memory region,
wherein the at least one DMA buffer is allowed to attach with the NPU based on the updating the MMU and the IOMMU.

11. The method as claimed in claim 10, comprising:
executing, by the electronic device, a DMA buffer backup operation, wherein the DMA buffer backup operation retains at least one of a context, a pipeline, and graphs associated with the GenAI model prior to allocation of the new memory region within the at least one DMA buffer of the plurality of DMA buffers, wherein the DMA buffer backup operation is executed without unloading a GenAI model, and wherein the execution of the DMA buffer backup operation preserves an operational state of the GenAI model.

12. The method as claimed in claim 1, comprising:
detecting, by the electronic device, at least one of a recovery operation and a restore operation associated with a GenAI application;
performing, by the electronic device, one of:
storing, by the electronic device, contents associated with the plurality of DMA buffers in a file releasing a physical memory region associated with the DMA buffer while maintaining buffer metadata, based on the recovery operation being triggered; and
allocating, by the electronic device, a new physical memory region for the plurality of DMA buffers by restoring contents from the file to the new physical memory region based on the restore operation being triggered.

13. The method as claimed in claim 12, wherein one or more clients access the plurality of DMA buffers through at least one virtual memory address, and
wherein the recovery operation comprises storing the at least one virtual memory address of the plurality of DMA buffers while releasing the new physical memory region, and
wherein the restore operation comprises mapping the new physical memory region to the at least one virtual memory address providing one or more clients access to the plurality of DMA buffers without remapping.

14. The method as claimed in claim 12, wherein the restore operation is deferred to be subsequent to the one or more clients attempting to access the plurality of DMA buffers through the at least one virtual memory address not mapped to the physical memory region.

15. The method as claimed in claim 1, comprising:
generating, by the electronic device, a page fault interrupt when the one or more clients access the plurality of DMA buffers;
handling, by the electronic device, the page fault interrupt by allocating a new physical memory region, restoring contents associated with the plurality of DMA buffers, and updating page tables to associate a virtual memory address with the new physical memory region.

16. An electronic device for recovering and restoring DMA buffers associated with a GenAI model, comprising:
at least one processor;
memory coupled to the at least one processor; and
a DMA buffer controller communicatively coupled to the at least one processor and the memory, wherein the DMA buffer controller is configured to:
obtain a state of the GenAI model based on one or more parameters;
determine a trigger for a GenAI model memory shrinker (GAMS) based on the state of the GenAI model;
determine at least one buffer from a plurality of DMA buffers associated with the GenAI model that are safe for recovering based on triggering the GAMS;
execute a GAMS memory recovery operation for the at least one DMA buffer from the plurality of DMA buffers; and
execute a GAMS buffer restore operation for the at least one DMA buffer from the plurality of DMA buffers, wherein the GAMS buffer restore operation comprises an explicit restore operation and an implicit restore operation.

17. The electronic device as claimed in claim 16, wherein the determining the trigger for the GAMS based on the state of the GenAI model comprises:
determining a trigger score based on at least one of a last inference time of the GenAI model, a usage pattern of the GenAI model, and the state of the GenAI model;
initiating a GAMS memory recovery operation based on the trigger score being less than 0.5; and
initiating a GAMS buffer restore operation based on the trigger score being greater than 2.

18. The electronic device as claimed in claim 16, wherein the determining the at least one buffer from the plurality of DMA buffers associated with the GenAI model that are safe for recovering comprises:
filtering each DMA buffer of the plurality of DMA buffers associated with the GenAI model based on a size threshold;
generating a first hash key for each DMA buffer of the plurality of DMA buffers during an initial loading of the GenAI model, wherein the first hash key generated is stored in a memory of the electronic device;
updating file descriptors associated with each DMA buffer of the plurality of DMA buffers during loading of the GenAI model based on a size and the hash key of each DMA buffer;
generating a second hash key for each DMA buffer of the plurality of DMA buffers during inference subsequent to updating the file descriptors;
comparing the second hash key for each DMA buffer with the first hash key for each DMA buffer; and
based on at least one hash key being same, determining that the at least one DMA buffer from the plurality of DMA buffers associated with the at least one hash key are safe for recovery, wherein one or more hash keys that are not the same are removed from the memory of the electronic device.

19. The electronic device as claimed in claim 16, wherein the executing the GAMS memory recovery operation for the at least one DMA buffer from the plurality of DMA buffers comprises:
retrieving file descriptors associated with the at least one DMA buffer of the plurality of DMA buffers that are determined safe for recovery, wherein the file descriptors are stored in a memory of the electronic device;
moving the file descriptors retrieved for the at least one DMA buffer to a NAND swap storage;
updating a memory management unit (MMU) and an input-output memory management unit (IOMMU) of the at least one DMA buffer of the plurality of DMA buffers to support the GAMS memory recovery operation based on the file descriptors retrieved for the at least one DMA buffer being moved to the NAND swap storage; and
performing an extension of the at least one DMA buffer of the plurality of DMA buffers to obtain a plurality of new DMA buffers.

20. A non-transitory computer readable medium storing instructions for recovering and restoring direct memory access (DMA) buffers associated with a generative artificial intelligence (GenAI) model, the instructions that when executed by at least one processor of an electronic device cause the electronic device to:
obtain a state of the GenAI model based on one or more parameters;
determine a trigger for a GenAI model memory shrinker (GAMS) based on the state of the GenAI model;
determine at least one buffer from a plurality of DMA buffers associated with the GenAI model that are safe for recovering based on triggering the GAMS;
execute a GAMS memory recovery operation for the at least one DMA buffer from the plurality of DMA buffers; and
execute a GAMS buffer restore operation for the at least one DMA buffer from the plurality of DMA buffers.
